(19) United States
(12) Patent Application Publication
(10) Pub. No.: US 2004/0228056 A1
(43) Pub. Date: Nov. 18, 2004

(54) Switching circuit with equity voltage division

(76) Inventor: Michael W. Vice, El Granada, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/438,998

(22) Filed: May 15, 2003

(51) Int. Cl. H02H 9/02

(52) U.S. Cl. 361/100

(57) ABSTRACT

A switching circuit that employs equity voltage division among a series of transistors to reduce the likelihood that the withstanding voltages of individual transistors will be exceeded. A switching circuit according to the present teachings include a series of transistors and circuitry for biasing the transistors such that a voltage input to the switching circuit divides substantially equally among the transistors when the transistors are in an off state.

### BACKGROUND OF THE INVENTION

1. Field of Invention

The present invention pertains to the field of electronic circuits. More particularly, this invention relates to switching circuits.

2. Art Background

A wide variety of systems commonly include switching circuits that employ field effect transistors (FETs) as switching devices. A typical switching circuit based on an FET provides an “on” state in which electrical current flows in the channel of the FET between the source and the drain of the FET and an “off” state in which electrical current is pinched off from flowing through the channel of the FET. The on/off state of a switching circuit based on an FET is usually controlled by bias voltages applied to the FET.

In many systems, the FETs in switching circuits are commonly subjected to relatively large voltages when in the off state. For example, a mobile telephone usually includes a switching circuit that connects its antenna to its receiver. Typically, the FET in the switching circuit when in its off state is subjected to a relatively large voltage drop from a transmit signal generated in the mobile telephone.

A relatively large voltage applied across the channel of an FET when it is in its off state may cause the FET to inadvertently switch to its on state. The maximum voltage that can be applied across the channel of an FET while maintaining its off state may be referred to as the withstanding voltage of the FET.

Unfortunately, an FET that inadvertently switches on when its withstanding voltage is exceeded may cause a variety of undesirable effects. In a mobile telephone, for example, a switching circuit that connects an antenna to a receiver may inadvertently switch on if the withstanding voltage of the FET in the switching circuit is exceeded, thereby severely distorting its transmit signal.

### SUMMARY OF THE INVENTION

A switching circuit is disclosed that employs equity voltage division among a series of transistors to reduce the likelihood that the withstanding voltages of individual transistors will be exceeded. A switching circuit according to the present teachings includes a series of transistors and circuitry for biasing the transistors such that a voltage input to the switching circuit divides substantially equally among the transistors when the transistors are in an off state.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a switching circuit with equity voltage division according to the present teachings;

FIG. 2 shows one embodiment of a switching circuit according to the present teachings including the components in its bias circuit;

FIGS. 3-5 show embodiments of a switching circuit according to the present teachings including the components in its bias circuit.

### DETAILED DESCRIPTION

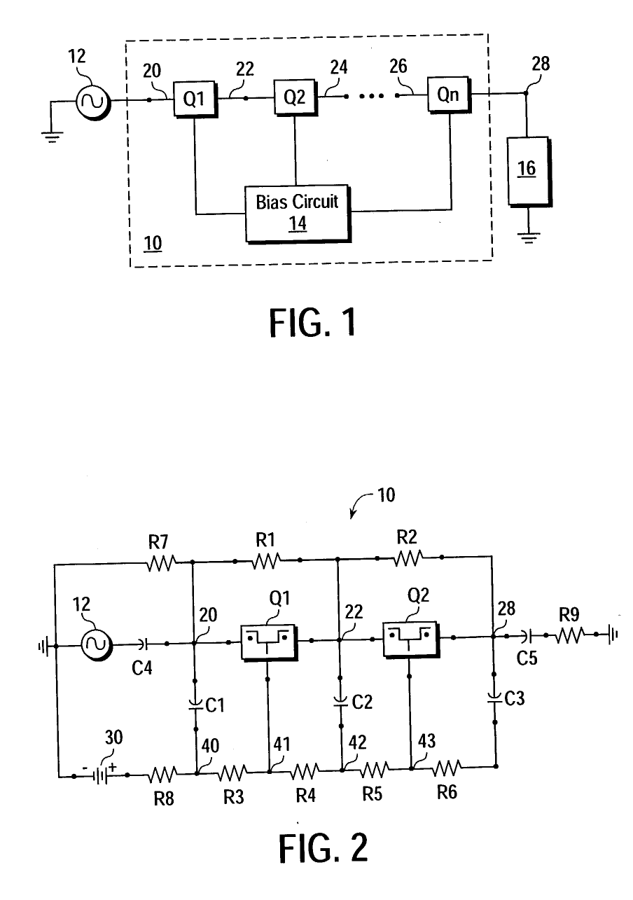

FIG. 1 shows a switching circuit 10 with equity voltage division according to the present teachings. The switching circuit 10 includes a set of FETs (transistors Q1 through Qn) that are arranged in series from a node 20 of the switching circuit 10 through a series of nodes 22-26 to a node 28 of the switching circuit 10. The switching circuit 10 includes a bias circuit 14 that biases the transistors Q1-Qn. An AC source 12 is shown coupled to the node 20 and a load 16 is shown connected to the node 28.

The transistors Q1-Qn and the components in the bias circuit 14 are selected and arranged such that the voltage generated by the AC source 12 is substantially equally divided among the transistors Q1-Qn when the transistors Q1-Qn are biased in the off state. For example, the AC voltage drop across the transistor Q1 between the nodes 20 and 22 is substantially equal to the voltage drop across the transistor Q2 between the nodes 22 and 24 which is substantially equal to the AC voltage drop across the transistor Qn between the nodes 26 and 28 when the transistors Q1-Qn are in an off state. As a consequence, each of the transistors Q1-Qn in its off state is subjected to 1/n of the total magnitude of the voltage from the AC source 12, thereby decreasing the likelihood that the withstanding voltages of the transistors Q1-Qn will be exceeded. The number and the sizes of the transistors Q1-Qn may be pre-selected such that the voltage drop across each transistor Q1-Qn does not exceed its withstanding voltage given the magnitude of the AC source 12.

The bias circuit 14 applies bias voltages to the transistors Q1-Qn to switch each transistor Q1-Qn between its on and off states as needed to open and close the switching circuit 10. The components in the bias circuit 14 are selected and arranged so that the substantially equal voltage division among the transistors Q1-Qn is maintained. For example, the selection and arrangement of components in the bias circuit 14 avoids the creation of AC paths to ground that might otherwise destroy the symmetry of the switching circuit 10 and defeat its equity voltage division.

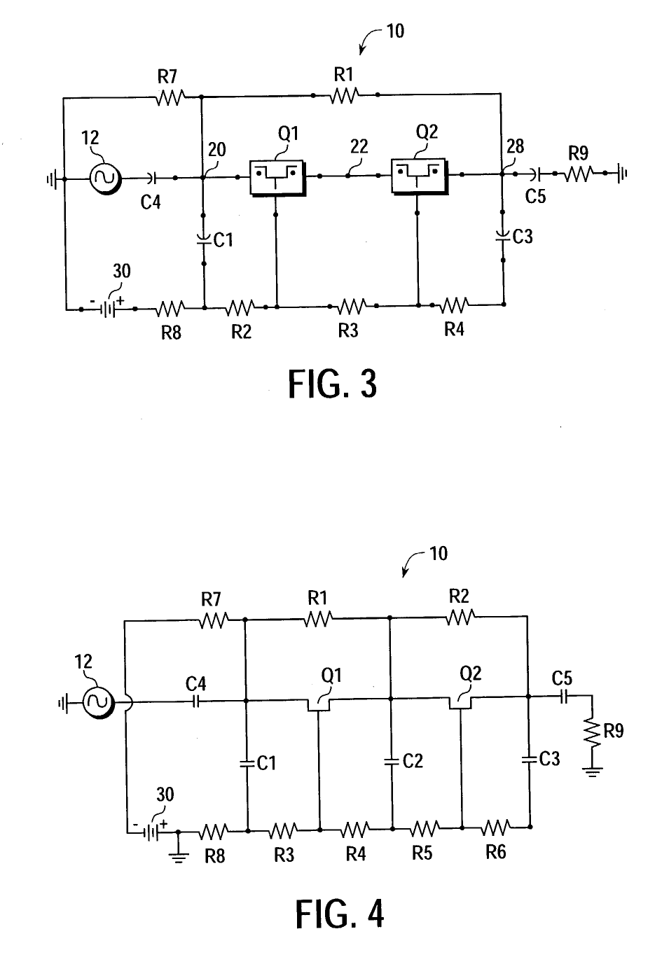

FIG. 2 shows one embodiment of the switching circuit 10 including the components in its bias circuit 14. This embodiment provides equity voltage division using two series connected transistors—the transistors Q1 and Q2, i.e. n=2. The transistors Q1 and Q2 are the switching FETs and are operated in series to maximize the overall withstanding voltage of the switching circuit 10.

The bias circuit 14 in this embodiment includes a DC supply 30, a set of resistors R1-R8, and a set of capacitors C1-C3. In this embodiment, the AC source 12 is AC coupled to the node 20 via a capacitor C4. The bias circuit 14 in the embodiment shown turns off the transistors Q1 and Q2 by applying −3 volts to the gates of the transistors Q1 and Q2. The resistors R1-R6 are selected such that R1=R2, R3=R5, and R4=R6. Thus, in the absence of resistors R7, R8 and the DC supply 30 the voltage drop across the transistor Q1 between the nodes 20 and 22 is substantially equal to the voltage drop across the transistor Q2 between the nodes 22 and 28.

The resistors R7, R8 and the DC supply 30 are arranged so as to not upset the symmetry of voltage division across the transistors Q1 and Q2. The DC supply 30 is tied in through the resistors R7 and R8. The capacitors C1-C3 AC couple the resistor divider of R3-R6 to the transistors Q1-Q2.

The terminals of the resistors R7 and R8 that are opposite of ground have the same AC potential. The DC supply 30 appears as a circuit that is in parallel with the AC source 12 from an AC perspective. There are no additional paths through which current can escape from the nodes 22, 28 to ground and all of the AC current that enters the node 20 and proceeds into the first transistor Q1 flows through to the node 28. Thus, the AC current in the transistor Q1 equals the AC current in the transistor Q2. Given that the transistors Q1 and Q2 are surrounded by substantially identical components and provided that the size of the transistors Q1 and Q2 are substantially similar, the AC voltage drop is substantially equally divided among the transistors Q1 and Q2.

The resistors R1, R2, and R7 provide a DC reference for the channels of the transistors Q1 and Q2 to ground. The capacitors C4 and C5 provide the channels of the transistors Q1 and Q2 with DC isolation from the AC source 12 and the load R9. The resistors R3-R6 connect the gates of the transistors Q1 and Q2 to the DC supply-30.

The entire ladder structure defined by the resistors R1-R6, the capacitors C1-C3, and the transistors Q1-Q2 may be viewed as a periodic ladder structure in which each stage of the ladder structure is substantially similar to the last including substantially similar arrangements of components with substantially similar component values. As a consequence, an input voltage at the node 20 drops equally across the transistors Q1 and Q2 because each ladder stage has the same impedance as the previous stage.

When the DC supply 30 voltage is below the threshold voltage of the transistors Q1 and Q2, the switching circuit 10 is off, and the voltage at the node 28 is close to zero. When the DC supply 30 voltage is above the threshold voltage of the transistors Q1 and Q2, the switching circuit 10 is on and signal energy from the AC source 12 is effectively coupled to the load R9.

In embodiments in which enhancement mode FETs are used as the transistors Q1 and Q2, a finite amount of gate current should be supplied in the on state. The appropriate amount of gate current may be supplied through the gate bias resistors. Other methods may be employed to apply the appropriate gate bias voltages to the FETs. In addition, either pole of the DC supply 30 may be referenced to ground.

If an even number of transistors is used to form the switching circuit 10, its ladder structure is preferably composed of substantially identical pairs of ladder sections, i.e. R3=R5, R4=R6, R1=R2. In addition, the widths W of the transistors Q1 and Q2 are substantially equal, i.e. W(Q1)=W(Q2). Alternatively, if an even number of transistors is used to form the switching circuit 10, its ladder structure is preferably composed of mirror image ladder sections, i.e. R3=R6, R4=R5, R1=R2, and W(Q1)=W(Q2).

If an odd number of transistors is used to form the switching circuit 10, the ladder structure is preferably composed of substantially similar sections, i.e. R3=R5, R4=R6, R1=R2, and W(Q1)=W(Q2).

In one embodiment, the resistors connecting each gate to the corresponding FET source and drain may be identical, i.e. R3=R4, and R5=R6.

The nodes 40-43 have paths to ground through the resistor R8. The electrical current paths to ground from each node 40-43 includes the node 20 or nodes that are the AC equivalent to the node 20. Thus, the AC signal in the switch 10 that flows past the node 20 and proceeds into the first transistor Q1 has no escape from the switch structure until it emerges from the node 28. This maintains substantial equity voltage division in the switch 10.

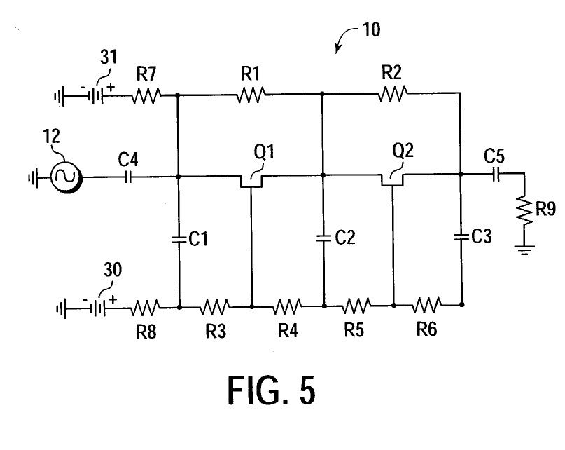

FIG. 3 shows another embodiment of the switching circuit 10 including the components in its bias circuit 14. In this embodiment, the connection to node 22 is eliminated and the capacitor C2 is eliminated and the resistors R4 and R5 are merged into R11 where preferably R11=2R3=2R6.

FIG. 4 shows yet another embodiment of the switching circuit 10. In this embodiment, the opposite side of the DC supply 30 is referenced to ground in comparison to the embodiments shown above.

FIG. 5 shows still another embodiment of the switching circuit 10. In this embodiment, two separate DC supplies 30-31 are employed.

Each transistor in a ladder structure of a switching circuit according to the present teachings operates beneficially from having. the magnitude of AC gate to source voltage being equal to the AC gate to drain voltage. This is in addition to the benefit derived from having substantially equal AC voltage drops across each transistor. It is also preferable that the transistors used in the ladder structure be formed symmetrically, so that no physical distinction exists between the source and drain terminals.

A switching circuit according to the present teachings provide a high power switch that creates a relatively low on state insertion loss as well as a relatively high off state isolation and withstanding voltage. The present teachings enable the use of a relatively low overall transistor size in comparison to prior art schemes. The present techniques yield an off state withstanding voltage that is proportional to the number of transistors that are arranged in series. This lowers the number series transistors required to achieve a particular off state withstanding voltage and consequently lowers the insertion loss and final die size.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A switching circuit, comprising:
a series of transistors;
circuitry for biasing the transistors such that a voltage input to the switching circuit divides substantially equally among the transistors when the transistors are in an off state.

2. The switching circuit of claim 1, wherein the transistors are selected such that a voltage drop across each transistor from the voltage input does not exceed a withstanding voltage of the transistors.

3. The switching circuit of claim 1, wherein the circuitry for biasing includes an arrangement of components that is selected to maintain a substantially equal voltage division among the transistors.

4. The switching circuit of claim 1, wherein the switching circuit is arranged as a ladder structure having a series of stages in which each stage has a substantially similar arrangement of components.

5. The switching circuit of claim 4, wherein the components in each stage have substantially similar component values.

6. The switching circuit of claim 1, wherein the switching circuit is arranged as a ladder structure having a series of stages such that a substantially similar amount of electrical current flows through each stage.

7. The switching circuit of claim 1, wherein the circuitry for biasing includes a DC supply that is connected such that the DC supply appears as a circuit that is in parallel with the voltage input from an AC perspective.

8. The switching circuit of claim 1, wherein the circuitry for biasing includes a DC supply that is connected such that the DC supply appears as a circuit that is in parallel with a load from an AC perspective.

9. The switching circuit of claim 1, wherein the circuitry for biasing includes a pair of DC supplies that are connected such that each DC supply appears as a circuit that is in parallel with the voltage input from an AC perspective.

10. The switching circuit of claim 1, wherein the circuitry for biasing includes a pair of DC supplies that are connected such that each DC supply appears as a circuit that is in parallel with a load from an AC perspective.

11. The switching circuit of claim 1, wherein the switching circuit is arranged as a ladder structure having a series of stages in which each stage has a substantially similar impedance.

12. A method for providing a switching circuit, comprising the steps of:
providing a series of transistors;
biasing the transistors such that a voltage input to the switching circuit divides substantially equally among the transistors when the transistors are in an off state.

13. The method of claim 12, further comprising the step of selecting the transistors such that a voltage drop across each transistor from the voltage input does not exceed a withstanding voltage of the transistors.

14. The method of claim 12, wherein the step of biasing comprises the step of selecting an arrangement of components that maintains a substantially equal voltage division among the transistors.

15. The method of claim 14, wherein the step of selecting an arrangement of components comprises the step of selecting a ladder structure having a series of stages in which each stage has a substantially similar arrangement of components.

16. The method of claim 15, wherein the step of selecting an arrangement of components further comprises the step of selecting the components in each stage to have substantially similar component values.

17. The method of claim 14, wherein the step of selecting an arrangement of components comprises the step of selecting a ladder structure having a series of stages such that a substantially similar amount of electrical current flows through each stage.

18. The method of claim 12, wherein the step of biasing comprises the step of connecting a DC supply such that the DC supply appears as a circuit that is in parallel with the voltage input from an AC perspective.

19. The method of claim 12, wherein the step of biasing comprises the step of connecting a DC supply such that the DC supply appears as a circuit that is in parallel with a load from an AC perspective.

20. The method of claim 12, wherein the step of biasing comprises the step of connecting a pair of DC supplies such that each DC supply appears as a circuit that is in parallel with the voltage input from an AC perspective.

21. The method of claim 12, wherein the step of biasing comprises the step of connecting a pair of DC supplies such that each DC supply appears as a circuit that is in parallel with a load from an AC perspective.

22. The method of claim 12, wherein the step of biasing comprises the step of selecting an arrangement of components that forms a ladder structure having a series of stages in which each stage has a substantially similar impedance.
